(19) United States
(12) Patent Application Publication
(10) Pub. No.: US 2022/0192077 A1
(43) Pub. Date: Jun. 23, 2022

(54) VERTICAL FARM SEEDING APPARATUS AND METHOD

(71) Applicant: Samuel WESTLIND, Bozeman, MT (US)

(72) Inventor: Samuel WESTLIND, Bozeman, MT (US)

(21) Appl. No.: 17/605,824

(22) PCT Filed: Apr. 22, 2020
(86) PCT No.: PCT/US2020/029267

§ 371 Date: Oct. 22, 2021

Related U.S. Application Data
(60) Provisional application No. 62/837,967, filed on Apr. 24, 2019.

(51) Int. Cl. A01C 1/04; A01G 31/02; A01C 7/20

(52) U.S. Cl. CPC A01C 1/042; A01C 2001/048; A01C 7/20; A01G 31/02

(57) ABSTRACT

A seeding apparatus for seeding agricultural seeds, seedlings and/or clones into a manufactured growth media of an indoor hydroponic growth system. The seeding apparatus including a media strip supply line configured to supply a quantity of consumable media strip for positioning within a linear aperture of a manufactured growth media, a depth gauge configured to fold the consumable media strip into a first part and a second part with a fold positioned therebetween, and to force the fold towards a bottom of the linear aperture of the manufactured growth media with the first part and the second part of the consumable media strip residing against walls defined by the linear aperture, and a seed supply line configured to introduce a metered quantity of agricultural seeds, seedlings and/or clones into the folded, consumable media strip.

### RELATED APPLICATION INFORMATION

This application claims the benefit of U.S. Provisional Application No. 62/837,967 filed Apr. 24, 2019, the contents of which are fully incorporated herein by reference.

### TECHNICAL FIELD

The present disclosure relates generally to hydroponic farm planting apparatuses and methods, and more particularly to an apparatus and method for direct, in situ, placement of seeds, seedlings and clones into a manufactured growth media.

### BACKGROUND

Commodity agriculture, such as wheat and other cereal grains, often utilize grain drills, air seeders, and other seeding machines to assist in planting. In such systems, seeds are typically kept in a large hopper which supplies a plurality of seed meters. An individual seed meter is associated with each planting unit. The seed meter, in turn, directs the metered seed through a seed tube to a seeding apparatus having a seed entry passage. Frequently, the seed entry passage is sloped rearward to impart a rearward velocity component on the seed relative to the forward motion of the seeding machine. A furrow opener forms a planting furrow immediately in front of the seeding apparatus. The seeding apparatus lies adjacent to the furrow opener in its shadow. The seed entry passage directs the seed into the planting furrow, which is closed by a furrow closing wheel. One example, of such a seeding system is disclosed in U.S. Pat. No. 7,168,376, the contents of which are hereby incorporated by reference herein to the extent that the contents do not contradict the teachings herein.

Hydroponic systems, such as that disclosed in Patent Cooperation Treaty App Ser. No. PCT/US2018/062035, the contents of which are hereby incorporated by reference herein, provide an excellent use of space and resources in the growth of agricultural crops; however certain aspects of their use can be labor-intensive. In particular, planting of agricultural crops within the manufactured growth media of hydroponic systems can require significant human involvement. Often times, seedlings are started in trays containing a plurality of plugs, and then at an appropriate time during the growth cycle, the plugs are inserted into the manufactured growth media where the agricultural crop grows to maturity. Although there have been various efforts to reduce the labor intensity of planting operations, further improvements are desired. The present disclosure addresses this concern.

### SUMMARY OF THE DISCLOSURE

Embodiments of the present disclosure provide an apparatus and method for seeding agricultural seeds, seedlings and/or clones into a manufactured growth media of an indoor hydroponic growth system. In one embodiment, the seeding apparatus can include a media strip supply line, depth gauge and seed supply line. The media strip can be configured to supply a quantity of consumable media strip for positioning within a linear aperture of a manufactured growth media. The depth gauge can be configured to fold the consumable media strip into a first part and a second part with a fold positioned therebetween, and to force the fold towards a bottom of the linear aperture of the manufactured growth media with the first part and the second part of the consumable media strip residing against walls defined by the linear aperture. The seed supply line can be configured to introduce a metered quantity of agricultural seeds, seedlings and/or clones into the folded, consumable media strip.

In one embodiment, the depth gauge can be in the form of a wheel. In one embodiment, the consumable growth media can comprise at least one of biodegradable hemp, felt, strip, scrim, voile, and/or muslin material. In one embodiment, the consumable growth media can be stored on a spool prior to introduction into the manufactured growth media.

In one embodiment, the seeding apparatus can further include a supplemental supply line configured to introduce a supplemental material and to the folded, consumable media strip. In one embodiment, the supplemental material can be at least one of organic growth material, fertilizer and/or an agricultural chemical. In one embodiment, the agricultural seeds, seedlings and/or clones can be introduced via a conveyor belt. In one embodiment, the seeding apparatus can be stationary. In other embodiments, the seeding apparatus can be configured to movably traverse over the surface of a manufactured growth media.

In one embodiment, only the consumable media strip makes direct contact with the manufactured growth media. In one embodiment, the seeding apparatus further includes a sharpened edge configured to open the linear aperture of the manufactured growth media.

Another embodiment of the present disclosure provides a seeding system for seeding agricultural seeds, seedlings and/or clones into a manufactured growth media of an indoor hydroponic growth system. The seeding system can include a plurality of seeding apparatuses positioned in a spaced apart configuration to enable seeding of agricultural seeds, seedlings and/or clones in parallel rows. Each of the seeding apparatuses can include: a media strip supply line configured to supply a quantity of consumable media strip for positioning within a linear aperture of a manufactured growth media; a depth gauge configured to fold the consumable media strip into a first part and a second part with a fold positioned therebetween, and to force the fold towards a bottom of the linear aperture of the manufactured growth media with the first part and the second part of the consumable media strip residing against walls defined by the linear aperture; and a seed supply line configured to introduce a metered quantity of agricultural seeds, seedlings and/or clones into the folded, consumable media strip.

Yet another embodiment of the present disclosure provides a method of seeding agricultural seeds, seedlings and/or clones into a manufactured growth media of an indoor hydroponic growth system, the method including: inserting a consumable media strip into a linear aperture of a manufactured growth media, wherein a depth gauge folds the media strip into a first part and a second part with a fold positioned there between, and forces the fold towards a bottom of the linear aperture with the first part and the second part of the consumable media strip residing against walls defined by the linear aperture; inserting a metered quantity of agricultural seeds, seedlings and/or clones into the folded media strip via a seed supply line, whereupon removal of the depth gauge a natural resiliency of the manufactured growth media forces the first part and the second part of the folded, consumable media strip closed thereby encapsulating the agricultural seeds, seedlings and/or clones therewithin.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable. The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a manufactured growth media of an indoor hydroponic growth system, in accordance with an embodiment of the disclosure.

FIG. 2 is a perspective view depicting a seeding apparatus defining a slit in the manufactured growth media of FIG. 1 and introducing a folded media strip into said slit, in accordance with an embodiment of the disclosure.

FIG. 3 is a perspective, partial cross-sectional view depicting the seeding apparatus of FIG. 2 introducing agricultural seeds and supplemental material into the folded media strip, in accordance with an embodiment of the disclosure.

FIG. 4 is a perspective view depicting a natural bias of the manufactured growth media forcing the folded media strip of FIG. 3 closed, thereby encapsulating the agricultural seeds and supplementary material within the folded media strip.

FIG. 5 is a perspective view of a hydroponic seeding system having multiple seeding apparatuses, in accordance with an embodiment of the disclosure.

FIG. 6 is a profile view depicting the planting of clones via a clone supply line and a first embodiment of a clone boot, in accordance with an embodiment of the disclosure.

FIG. 7 is a profile view depicting the planting of clones via a clone supply line and a second embodiment of a clone boot, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

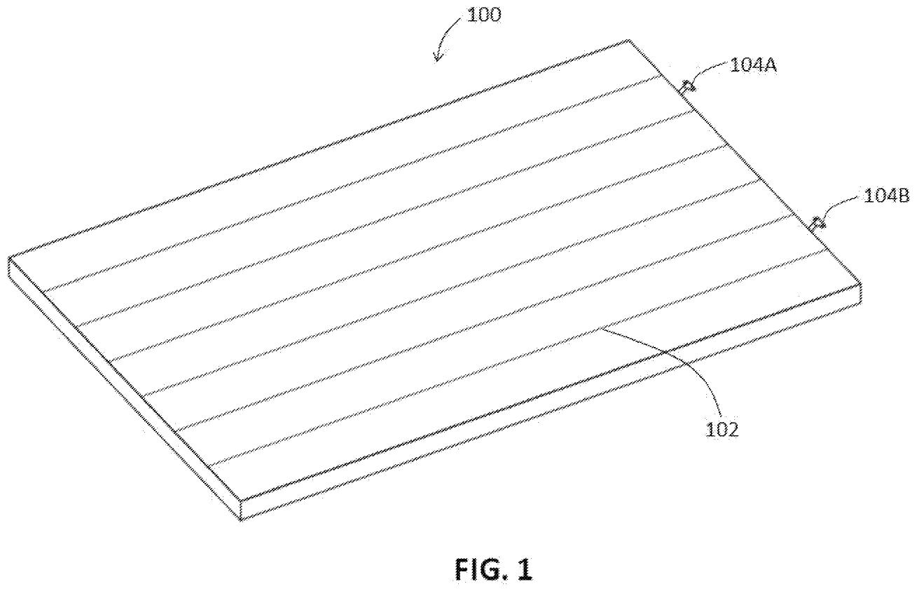

Referring to FIG. 1, a manufactured growth media 100 of an indoor hydroponic growth system is depicted in accordance with an embodiment of the disclosure. In one embodiment, the manufactured growth media 100 includes one or more slits 102 (alternatively referred to herein as “apertures”) of a predefined depth for the planting of agricultural crops. In other embodiments, the one or more slits or apertures 102 are created during the seeding or planting process. In some embodiments, the manufactured growth media 100 includes one or more brackets 104 configured to enable the manufactured growth media 100 to be hung in a space-saving vertical orientation, such as that disclosed in Patent Cooperation Treaty App Ser. No. PCT/US2018/062035.

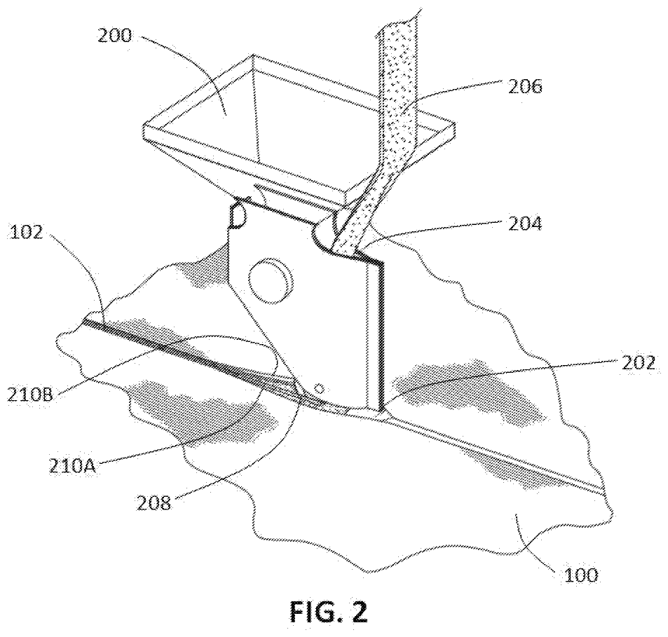

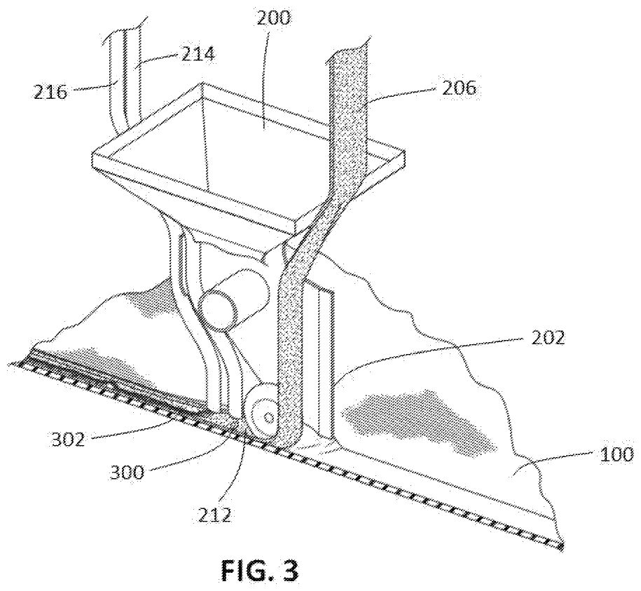

Referring to FIG. 2, a seeding apparatus 200 is depicted in accordance with an embodiment of the disclosure. In one embodiment, the seeding apparatus 200 includes a sharpened edge 202 configured to slice, cut or otherwise open the slit 102 of a predefined depth in the manufactured growth media 100, as the seeding apparatus 200 is traverses across the manufactured growth media 100. As further depicted in FIG. 2, in one embodiment, the seeding apparatus 200 can include a media strip supply line 204 configured to introduce a consumable media strip 206 into the slit 102 during the planting process. In one embodiment, a depth gauge 208 can be configured to fold the media strip 206 into a first part 210A and a second part 210B with a fold 212 (depicted in FIG. 3) positioned therebetween, such that the fold is forced towards a bottom of the slit 102, while the first part 210A and the second part 210B reside against walls defined by the slit 102. In some embodiments, the depth gauge 208 can be in the form of a wheel; although other depth gauge configurations are also contemplated.

In some embodiments, the consumable media strip 206 can be constructed of a variety of materials including at least one of a biodegradable Terrafiber™ hemp mat strip, Biostrate™ felt strip, cheesecloth, gauze, scrim, voile, and/or muslin; although it is contemplated that other materials may also be utilized. The materials used to form the consumable media strip 206 can have a variety of physical qualities (e.g., moisture retention, breathability, threadcount, weave, etc.) enabling selection of an appropriate consumable media strip 206 to support the needs of the particular seed, seedlings and/or clone to be grown. For example, the relatively large seeds of peas and beans, which tend to grow better in drier conditions, can be planted in a consumable media strip 206 constructed of a low moisture retention, breathable, low threadcount material. By contrast, plants such as arugula can be planted in a consumable media strip 206 constructed of a higher threadcount material as an aid in retaining the relatively small seeds in a desired position within the manufactured growth media. In some embodiments, the threadcount of the consumable media strip 206 can vary in a threadcount range of between about 24×20 threads per square inch and about 44×36 threads per square inch; although other threadcounts are also contemplated.

Accordingly, in some embodiments, consumable media strip 206 can play an important role in the growth cycle. Among other things, the consumable media strip 206 serves to inhibit plant the seeds from being lost in the manufactured growth media 100, enable circulation of air and nutrients, and retain moisture for improved germination and growth. For example, hydroponic and aeroponic systems, the physical qualities of the consumable media strip 206 can serve to regulate distribution of liquid and aerosolized nutrients evenly throughout the root zone environment of the plants. The physical qualities of the consumable media strip 206 can also serve to regulate the introduction of moisture and nutrients into generally hydrophilic organic materials, which may optionally be added to the consumable media strip 206. In some embodiments, the consumable media strip 206 can further enable ease in removal of root systems after harvest. In some embodiments, the consumable media strip 206 can be stored on the spool or other container/cartridge prior to introduction into the manufactured growth media 100.

Referring to FIG. 3, in some embodiments, the seeding apparatus 200 can include a seed supply line 214 configured to introduce a metered quantity of agricultural seeds 300, seedlings and/or clones into the folded media strip 206. As further depicted in FIG. 3, in one embodiment, the seeding apparatus 200 can include a supplemental supply line 216 configured to introduce supplemental material 302, which can include at least one of organic growth material, fertilizer and/or other agricultural chemicals into the folded media strip 206.

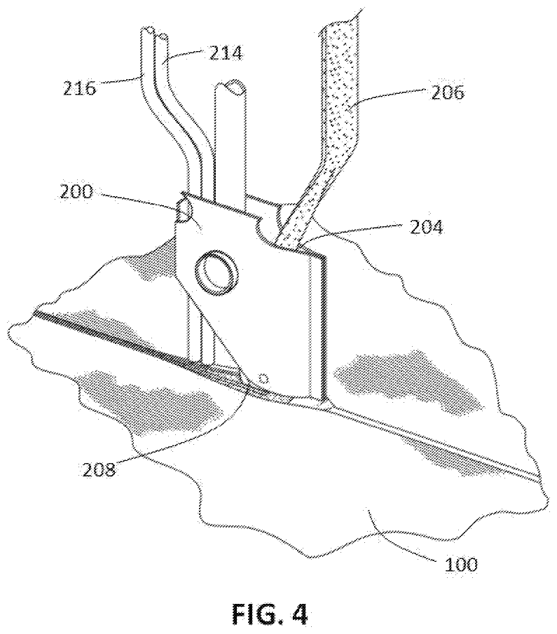

Referring to FIG. 4, in some embodiments, the sharpened edge 202 of the seeding apparatus can be configured to open the aperture 102 in the manufactured growth media 100 for placement of the media strip 206. In other embodiments, one or more apertures 102 can be predefined in the manufactured growth media 100. In embodiments with predefined apertures 102, no portion of the seeding apparatus 200 makes contact with the manufactured growth media 100 directly; rather the depth gauge 208 guides, places, folds and seats the media strip 206 within the predefined apertures 102, such that only the media strip 206 contacts the manufactured growth media 100 directly.

Accordingly, in some embodiments, an applied pressure from the depth gauge 208 can act to temporarily force the first part 210A and the second part 210B of the folded media strip 206 apart, thereby enabling the agricultural seeds 300 and the supplemental material 302 to be introduced therein. Upon removal of the depth gauge 208 from the media strip 206, a natural resiliency or bias of the manufactured growth media 100 naturally closes the aperture 102, thereby forcing the first part 210A and the second part 210B of the folded media strip 206 closed, thereby encapsulating the agricultural seeds 300 and the supplemental material 302 within the folded media strip 206, thereby completing the planting process. In some embodiments, the natural resiliency or bias of the manufactured growth media 100 remains throughout the entire growth cycle.

Upon completion of the growth cycle, and harvesting of any harvestable portion of the grown plants, the root systems of the plants can be removed from the manufactured growth media 100 by removal of the media strip 206 from the growth media 100. For example, in some embodiments, removal of the root systems can be affected by grabbing one end of the media strip 206 and pulling it from the aperture 102. Thereafter, the manufactured growth media 100 can optionally be cleaned and prepared for reseeding.

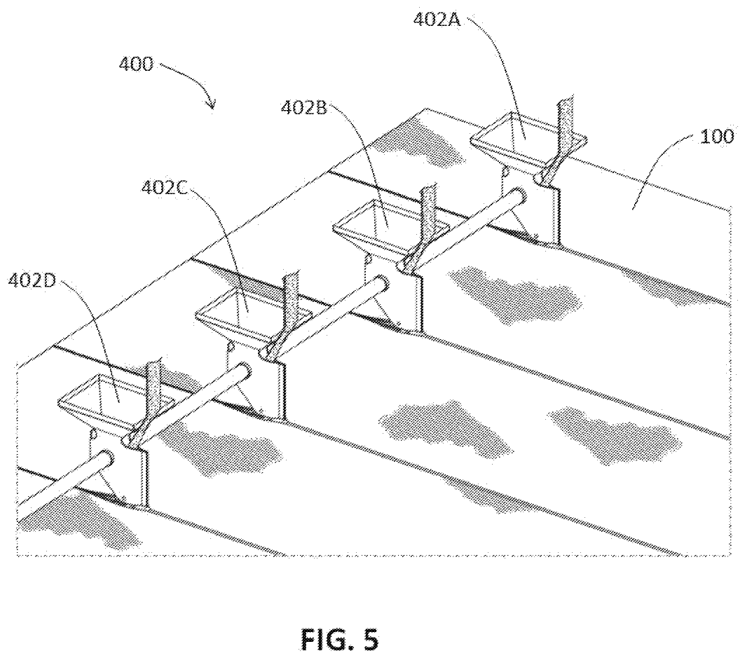

Referring to FIG. 5, a seeding system 400, including a plurality of seeding apparatuses 402A-D in a parallel, spaced apart configuration, is depicted in accordance with an embodiment of the disclosure. In some embodiments, the seeding system 400 can be traversed across a surface of the manufactured growth media 100, thereby enabling the planting of seeds, seedlings or clones and distinct rows. In some embodiments, the seeding system 400 can be dragged or force over the surface of a stationary manufactured growth media 100. For example, in some embodiments, the seeding system 400 can be operably coupled to one or more wheels to aid in movement of the seeding system 400 across the manufactured growth media as well as to maintain an ideal depth of the depth gauge 208 during the seeding process. In other embodiments, the seeding system 400 can be stationary, and the manufactured growth media 100 can be moved relative to the seeding system 400. For example, in some embodiments, the manufactured growth media 100 can pass through a seeding station in which the seeding system 400 is positioned prior to placement of the growth media 100 in a growth chamber.

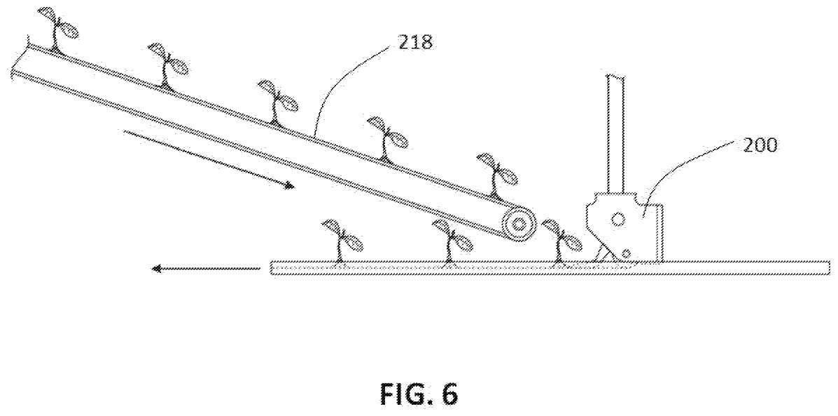

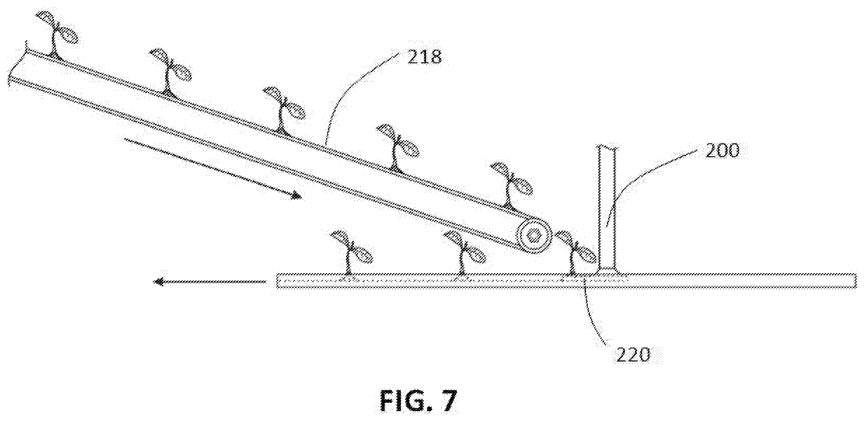

Referring to FIGS. 6 and 7, in some embodiments, the seeding apparatus 200/200′ can include a clone or seedling supply line 218 configured to supply at least one of seedlings and/or clones to the seeding apparatus 200/200′ during the seeding process. In some embodiments, the seedling supply line 218 can be at least one of a conveyor, gravity fed chute or the like. In one embodiment, the seeding apparatus 200′ can include a boot flange 220 configured to retain the folded media strip and/or slit 102 in an open configuration while the seedling is planted in the manufactured growth media 100.

Embodiments of the present disclosure provide a media seeding system configured to enable, in situ, mechanized and automated seeding of seeds, seedlings and clones directly into manufactured media field apertures. The media manufactured field seeding system can include a seeding apparatus. The seeding apparatus can include a depth gauge. The depth gauge can be configured to be statically fixed or rotate. The seeding apparatus can include one or more supply line attachments for a media strip, seeds, seedlings, clones or amendments. The seeding apparatus can include side flanges. The seeding apparatuss can be greater than one to match the aperture count on a manufactured media field. Such a seeding apparatus system for manufactured fields reduces the processes of seeding and propagation to the efficiencies of assembly processes thus establishing the efficiency gains necessary for scaling hydroponic indoor commercial agriculture.

In one embodiment, the seeding apparatus can be coupled to a supply line supplying seed, In one embodiment, the seeding apparatus can be coupled to a supply line supplying media strip such as a biodegradable Terrafibre™ hemp mat strip or a Biostrate™ felt strip. In another embodiment, any low cost commercially available media may be utilized. In one embodiment, the media strip can be of different widths and thicknesses. In one embodiment, the media strip is durable and or reinforced to allow pulling of the strip out of the aperture after harvest is completed. In one embodiment, more than one media strip may be used. In one embodiment, the seeding apparatus is the guide for the media strip. In one embodiment, the depth gauge opens and places the media strip into the manufactured media field apertures. In one embodiment, the seeding apparatus opens the manufactured media field apertures and the depth gauge presses and folds the media strip into the manufactured media field aperture while also keeping the media strip spread open to receive the one or more seeds. As the seeding apparatus advances, the manufactured media field aperture and media strip aperture firmly close around the seed. in one embodiment, the seeding apparatus assembly is static and the manufactured media field is pulled through the seeding line. As the manufactured media field is pulled through, the aperture is opened, the media is placed and seeded, and the aperture closes behind the seeding apparatus, thereby retaining the media strip firmly in place within the manufactured media field aperture, whereby the seed is firmly gripped within the media strip.

In one embodiment, the seeding apparatus assembly moves and the manufactured media field is stationary. In one embodiment, if the manufactured media fields are factory prepopulated with media strips, the seeding apparatus can open the aperture and the depth gauge can open the media strip to place seed within the media strip. In one embodiment, the seeding apparatus can have additional supply lines for azobactur, peat moss, polymer bound media and any other suitable input for crop production. In one embodiment, the seeding apparatus can be configured to slice an aperture directly into a polymer bound media field. In one embodiment, the media strip can be pre populated with seeds, seedlings or clones and then inserted into apertures an one embodiment, the seeding apparatus can directly place seed plugs or clones into the manufactured media field apertures. In one embodiment, the manufactured media field apertures can be full or partial depth.

Indoor farming systems are very similar to greenhouse hydroponic systems in that the growing space is expensive and needs to be utilized efficiently. While a seed station and a propagation station take up valuable space and require labor touch points, the density offered and visual germination confirmation for 100% germination makes it worthwhile for traditional systems verses growing from seed to harvest in situ and the extra system footprint required. With narrow profile vertical manufactured media fields, an aperture seeding system offers the most efficient means to seed and propagate in situ, thus eliminating human touch points, potential plant pathogens transfer and plant stress. Such an aperture seeded media field can be placed into the hydroponic system directly such as in a continuous production system, or can be placed into a vertical media field propagation chamber and later transferred to a production system.

With aperture seeding system of the present disclosure, seeds can be metered for even spacing or broadcast into an aperture in a manner that offers precise placement of seed for optimum plant canopy light requirements. For seedling plugs and or clone collars, a larger diameter seeding apparatus can open the aperture and the supply line of seedlings and or clones drop into place behind the seeding apparatus at the desired spacing. As the manufactured field advances the manufactured field aperture naturally closes around the seedling plug and/or clone collars.

Such a manufactured field aperture seeding system can seed fields on the horizontal plane or vertical plane. On the horizontal plane, a series of seeding apparatuss can be statically fixed and a manufactured field can be manually pulled through. Such a system requires little labor and allows an entire 76″×46″ 10 row field to be seeded as fast as the field can be pulled through. Generally this is approximately 30 to 60 seconds. In contrast to current production methods of manually transferring seedlings by hand, a time consuming process, a manufactured field aperture seedling system offers much efficiency gains.

Such a manufactured field aperture seeding system can also be on the vertical plane. Manufactured fields with horizontal apertures can be fed directly into the seeding station and directly into a vertical propagation chamber thus removing additional labor steps.

The single row seeder has the seed hopper directly above the metered shaft. The single row seeder has been modified to work on the patent pending commercially available AutoCrop LLC manufactured media fields. The seeder assembly sits on the surface of the manufactured growth media field. The seeder wheels turn the metered shaft as the seeder advances. The seeding apparatus spreads the manufactured growth media field aperture. A rotating depth gauge firmly inserts and folds a 0.75″ wide media strip into the manufactured growth media field aperture while also keeping the media strip spread open to receive the one or more seeds. As the seeding apparatus advances, the manufactured media field aperture and media strip aperture firmly close around the seed. One or more seeders can be mounted together to seed an entire manufactured growth media field at once. Additionally, one or more seeding apparatuses can be connected to a one or more remote seed supply by mechanical or air seeder supply lines. With multiple seed supply different crops can be seeded in alternate rows. Additionally, a seeding apparatus for manufactured growth media fields can seed on the horizontal or vertical plane. After the growth cycle and harvest is completed, the media strip is simply removed by pulling from one end and the manufactured growth media field is ready to be seeded anew.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A seeding apparatus for seeding agricultural seeds, seedlings and/or clones into a manufactured growth media of an indoor hydroponic growth system, the seeding apparatus comprising:
a media strip supply line configured to supply a quantity of consumable media strip for positioning within a linear aperture of a manufactured growth media;
a depth gauge configured to fold the consumable media strip into a first part and a second part with a fold positioned therebetween, and to force the fold towards a bottom of the linear aperture of the manufactured growth media with the first part and the second part of the consumable media strip residing against walls defined by the linear aperture; and
a seed supply line configured to introduce a metered quantity of agricultural seeds, seedlings and/or clones into the folded, consumable media strip.

2. The seeding apparatus of claim 1, wherein the depth gauge is in the form of a wheel.

3. The seeding apparatus of claim 1, wherein the consumable growth media comprises at least one of biodegradable hemp, felt, strip, scrim, voile, and/or muslin material.

4. The seeding apparatus of claim 1, wherein the consumable growth media is stored on a spool prior to introduction into the manufactured growth media.

5. The seeding apparatus of claim 1, further comprising a supplemental supply line configured to introduce a supplemental material and to the folded, consumable media strip.

6. The seeding apparatus of claim 5, wherein the supplemental material is at least one of organic growth material, fertilizer and/or an agricultural chemical.

7. The seeding apparatus of claim 1, wherein only the consumable media strip makes direct contact with the manufactured growth media.

8. The seeding apparatus of claim 1, further comprising a sharpened edge configured to open the linear aperture of the manufactured growth media.

9. The seeding apparatus of claim 1, wherein the agricultural seeds, seedlings and/or clones are introduced via a conveyor belt.

10. A seeding system for seeding agricultural seeds, seedlings and/or clones into a manufactured growth media of an indoor hydroponic growth system, the seeding system comprising:
a plurality of seeding apparatuses positioned in a spaced apart configuration to enable seeding of agricultural seeds, seedlings and/or clones in parallel rows, each of the seeding apparatuses including
a media strip supply line configured to supply a quantity of consumable media strip for positioning within a linear aperture of a manufactured growth media;
a depth gauge configured to fold the consumable media strip into a first part and a second part with a fold positioned therebetween, and to force the fold towards a bottom of the linear aperture of the manufactured growth media with the first part and the second part of the consumable media strip residing against walls defined by the linear aperture; and
a seed supply line configured to introduce a metered quantity of agricultural seeds, seedlings and/or clones into the folded, consumable media strip.

11. The seeding system of claim 9, wherein the seeding system is configured to be stationary.

12. The seeding system of claim 9, wherein the agricultural seeds, seedlings and/or clones are introduced via a conveyor belt.

13. The seeding system of claim 9, wherein the depth gauge is in the form of a wheel.

14. The seeding system of claim 9, wherein the consumable growth media comprises at least one of biodegradable hemp, felt, strip, scrim, voile, and/or muslin material.

15. The seeding system of claim 9, wherein the consumable growth media is stored on a spool prior to introduction into the manufactured growth media.

16. The seeding system of claim 9, further comprising a supplemental supply line configured to introduce a supplemental material and to the folded, consumable media strip.

17. The seeding system of claim 16, wherein the supplemental material is at least one of organic growth material, fertilizer and/or an agricultural chemical.

18. The seeding system of claim 9, wherein only the consumable media strip makes direct contact with the manufactured growth media.

19. The seeding system of claim 9, further comprising a sharpened edge configured to open the linear aperture of the manufactured growth media.

20. A method of seeding agricultural seeds, seedlings and/or clones into a manufactured growth media of an indoor hydroponic growth system, the method comprising:
inserting a consumable media strip into a linear aperture of a manufactured growth media, wherein a depth gauge folds the media strip into a first part and a second part with a fold positioned there between, and forces the fold towards a bottom of the linear aperture with the first part and the second part of the consumable media strip residing against walls defined by the linear aperture;
inserting a metered quantity of agricultural seeds, seedlings and/or clones into the folded media strip via a seed supply line, whereupon removal of the depth gauge a natural resiliency of the manufactured growth media forces the first part and the second part of the folded, consumable media strip closed thereby encapsulating the agricultural seeds, seedlings and/or clones therewithin.
